(19) United States
(12) Patent Application Publication
(10) Pub. No.: US 2015/0269502 A1
(43) Pub. Date: Sep. 24, 2015

(54) METHOD AND APPARATUS FOR FINDING PROCESS DEVIATIONS AND RECOMMENDING REPAIRS IN A BUSINESS PROCESS

(71) Applicant: Xerox Corporation, Norwalk, CT (US)

(72) Inventors: YASMINE CHARIF, Rochester, NY (US); Julien Bourdaillet, Rochester, NY (US); Andrés Quiroz Hernandez, Rochester, NY (US); JinHui Yao, Pittsford, NY (US)

(73) Assignee: Xerox Corporation, Norwalk, CT (US)

(21) Appl. No.: 14/218,450

(22) Filed: Mar. 18, 2014

(51) Int. Cl. G06Q 10/06

(52) U.S. Cl. CPC G06Q 10/0633

(57) ABSTRACT

A method, non-transitory computer readable medium, and apparatus for recommending a repair for a business process are disclosed. For example, the method identifies an empirical process graph that corresponds to a theoretical process graph of the business process, decomposes the theoretical process graph into one or more sub-process graphs, identifies a portion of the empirical process graph to compare to one of the one or more sub-process graphs, compares the portion of the empirical process graph to the one of the one or more sub-process graphs to calculate a remainder, repeats the identifying and the comparing for each one of the one or more sub-process graphs and recommends a list of one or more repairs, wherein each one of the one or more repairs corresponds to a respective remainder calculated in the comparing.

The present disclosure relates generally to management of business process flows and, more particularly, to a method and apparatus for finding process deviations and recommending repairs in a business process.

### BACKGROUND

Businesses are using process conformance checking to compare a process trace and a process model definition in order to find commonalities and discrepancies. When a process model and usage data disagree, this should lead to adaptations of the process model. This is what is referred to as process enhancement. Process enhancement includes process extension and repair.

Existing approaches to perform process repair include 1) replaying a process trace on a process model and identifying deviations, or 2) using an enhanced model (e.g., with a temporal perspective) to help visualize problems such as bottlenecks and waiting times, leading to structural changes. However, the main limitation of the former approach to repair is the lack of a formal method to combine information from multiple traces (i.e., formal can be defined as having statistical/probabilistic validity). This makes it difficult to assess how many process traces are sufficient to capture the process behavior or, if using all traces, which of these traces contain or constitute representative behavior. With the latter approach, the drawback is that the visualized problems are determined through subjective interpretations due to the lack of baseline for comparison.

### SUMMARY

According to aspects illustrated herein, there are provided a method, a non-transitory computer readable medium, and an apparatus for recommending a repair for a business process. One disclosed feature of the embodiments is a method that identifies an empirical process graph that corresponds to a theoretical process graph of the business process, decomposes the theoretical process graph into one or more sub-process graphs, identifies a portion of the empirical process graph to compare to one of the one or more sub-process graphs, compares the portion of the empirical process graph to the one of the one or more sub-process graphs to calculate a remainder, repeats the identifying and the comparing for each one of the one or more sub-process graphs and recommends a list of one or more repairs, wherein each one of the one or more repairs corresponds to a respective remainder calculated in the comparing.

Another disclosed feature of the embodiments is a non-transitory computer-readable medium having stored thereon a plurality of instructions, the plurality of instructions including instructions which, when executed by a processor, cause the processor to perform an operation that identifies an empirical process graph that corresponds to a theoretical process graph of the business process, decomposes the theoretical process graph into one or more sub-process graphs, identifies a portion of the empirical process graph to compare to one of the one or more sub-process graphs, compares the portion of the empirical process graph to the one of the one or more sub-process graphs to calculate a remainder, repeats the identifying and the comparing for each one of the one or more sub-process graphs and recommends a list of one or more repairs, wherein each one of the one or more repairs corresponds to a respective remainder calculated in the comparing.

Another disclosed feature of the embodiments is an apparatus comprising a processor and a computer readable medium storing a plurality of instructions which, when executed by the processor, cause the processor to perform an operation that identifies an empirical process graph that corresponds to a theoretical process graph of the business process, decomposes the theoretical process graph into one or more sub-process graphs, identifies a portion of the empirical process graph to compare to one of the one or more sub-process graphs, compares the portion of the empirical process graph to the one of the one or more sub-process graphs to calculate a remainder, repeats the identifying and the comparing for each one of the one or more sub-process graphs and recommends a list of one or more repairs, wherein each one of the one or more repairs corresponds to a respective remainder calculated in the comparing.

### BRIEF DESCRIPTION OF THE DRAWINGS

The teaching of the present disclosure can be readily understood by considering the following detailed description in conjunction with the accompanying drawings, in which:

FIG. 1 illustrates an example diagram of a theoretical process and an empirical process;

FIGS. 2A and 2B illustrate an example diagram of sub-processes from a decomposition of the theoretical process and a result for a comparison of the theoretical process with the empirical process;

FIG. 3 illustrates an example list of recommendations for one or more repairs;

FIG. 4 illustrates an example flowchart of one embodiment of a method for recommending a repair for a business process; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for finding process deviations and recommending a repair for a business process. As discussed above, businesses are using process conformance checking to compare process traces with a process model definition in order to find commonalities and discrepancies. When a process model and usage data disagree, this should lead to adaptations of the process model. This is what is referred to as process enhancement. Process enhancement includes process extension and repair. However, the current methods for repair have limitations that include a lack of a formal method to combine information from multiple traces or the visualized problems are determined through subjective interpretations due to the lack of baseline for comparison.

One embodiment of the present disclosure resolves the problems described above related to existing methods for repair and provides an objective and detailed method for identifying process deviations, recommending repairs and implementing repairs of a business process. The benefits of the methods described herein are that the disclosed method is capable of providing repair recommendations at different levels of detail, which is useful for large and complex processes to identify differences. The method relies on a sound probabilistic representation of usage data in order to capture the empirical process behavior, in that it includes a framework that enables the assessment of trace selections and the method yields more information (e.g., transitions, probabilities, and the like) that can be combined with other perspectives (e.g., temporal) to provide a more complete assessment.

As discussed above, companies are using business processes more and more to describe a particular operation or process. A business process (BP) defines the orchestration of automated services, human activities and machines' operations to achieve a specific goal. For example, a child support BP, which aims at establishing alimony orders, comprises activities such as locating a parent, establishing paternity, scheduling conferences, and the like.

However, in practice one or more of the activities may be different than the BP model. For example, the activity for locating a parent in the theoretical model of the BP may indicate using a white pages phone book. However, in practice the locating a parent activity may include checking social networking websites in addition to using the white pages phone book, in lieu of using the white pages phone book or performing the locating the parent activity at a different portion of the process than indicated in the theoretical model. One embodiment of the present disclosure automates the process of repairing the theoretical model of the BP to accurately reflect what is actually occurring in practice using an objective analysis and process.

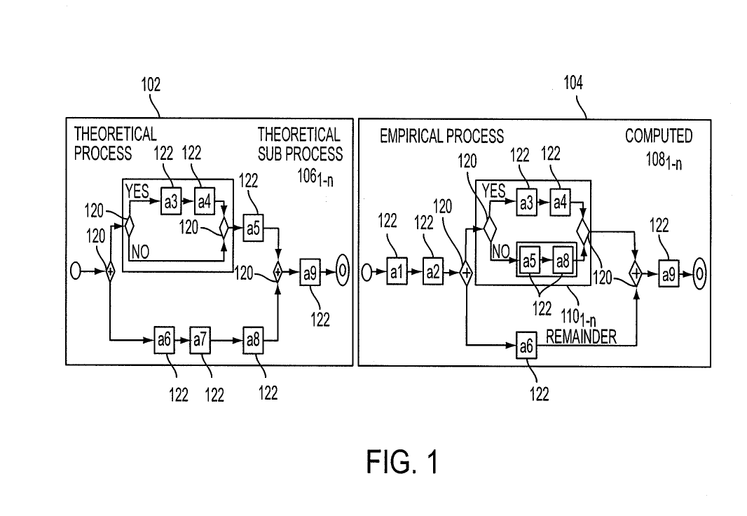

FIG. 1 illustrates an example of a theoretical process graph 102 that can be used to illustrate the BP, for example the child support BP. The theoretical process graph 102 may include one or more decision boxes 120 and one or more activity boxes 122. Each one of the activity boxes 122 may represent a different activity within the BP. Using the child support BP example discussed above, one of the activity boxes 122 may represent the “locating a parent” activity, another activity box 122 may represent the “establishing paternity” activity, another activity box 122 may represent the “scheduling conferences” activity, and so forth.

In one embodiment, companies may also perform process mining and business activity monitoring (BAM) to provide organizations with techniques to optimize the company's operation based on their BPs, make better informed business decisions, quickly address problem areas and re-position themselves to take full advantage of emerging opportunities. Process mining and BAM may include process discovery, process conformance and process enhancement.

In one embodiment, process discovery aims at collecting process usage data and formalizing BPs as they happen in practice. Process conformance compares usage data with the prescribed organization's BP to check whether and to what extent deviations exist. Process enhancement aims at extending or repairing a prescribed process model using the information collected in the usage data so that the BP model better reflects reality.

In one embodiment, the process mining and BAM data may be used to create an empirical process graph 104 of the business process. The empirical process graph 104 may be a visual representation of the decisions and activities that are actually occurring versus the decisions and activities that theoretically should be occurring in the theoretical process graph 102. One embodiment of creating the empirical process graph 104 is disclosed in U.S. patent application Ser. No. 14/081,203, filed on Nov. 15, 2013, entitled “A Method and System For Clustering, Modeling and Visualizing Process Models From Noisy Logs,” assigned to Xerox® Corporation and herein incorporated by reference in its entirety.

In one embodiment, the empirical process graph 104 may also include one or more decision boxes 120 and one or more activity boxes 122. In one embodiment, the empirical process graph 104 may include additional decision boxes 120 or activity boxes 122 or may be missing some decision boxes 120 or activity boxes 122 compared to the theoretical process graph 102.

One embodiment of the present disclosure provides a repair recommendation and method to add, remove, move or modify various activity boxes 122 of the theoretical process graph 102 based upon a comparison of the theoretical process graph 102 to the empirical process graph 104. In one embodiment, the theoretical process graph 102 may be broken into one or more sub-process graphs 106₁ to 106ₙ (also referred to herein collectively as a sub-process graph or graphs 106). The empirical process graph 104 may have portions or counterparts 108₁ to 108ₙ (also referred to herein collectively as a portion or portions 108) that correspond to each one of the sub-process graphs 106.

In one embodiment, a difference between the comparison of each one of the sub-process graphs 106₁ to 106ₙ and the corresponding portions 108₁ to 108ₙ may be used to identify respective remainders 110₁ to 110ₙ (also referred to herein collectively as a remainder or remainders 110). The remainders may correspond to each one of the repairs that may be recommended to a user.

At a high level, the present method for recommending a repair of a business process may include the steps of discovering an empirical process that corresponds to the given theoretical process, decomposing the theoretical process into sub-processes, finding portions of the empirical process to compare with these sub-processes and providing a recommendation of a list of one or more repairs found based on the comparison. As discussed above, the theoretical process graph 102 may be constructed by a business analyst and stored in a database and the empirical process graph 104 may be created based on the actual data logs of the business process. One embodiment of discovering the empirical process graph 104 that corresponds specifically to a given theoretical process model is disclosed in U.S. patent application Ser. No. 14/017,861, filed on Sep. 4, 2013, entitled “Business Process Behavior Conformance Checking and Diagnostic Method And System Based On Theoretical And Empirical Process Models Built Using Probabilistic Models And Fuzzy Logic,” assigned to Xerox® Corporation and herein incorporated by reference in its entirety.

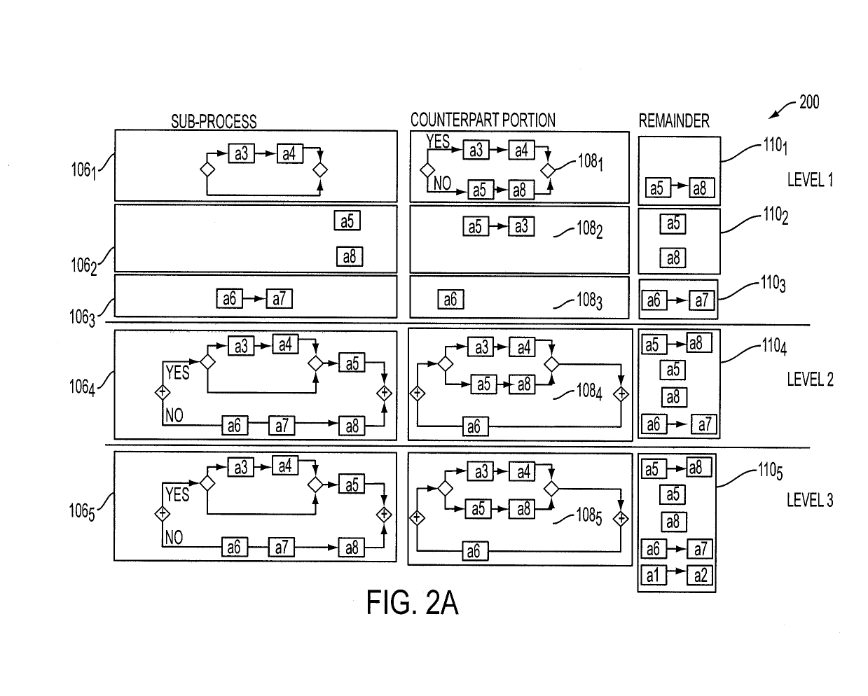

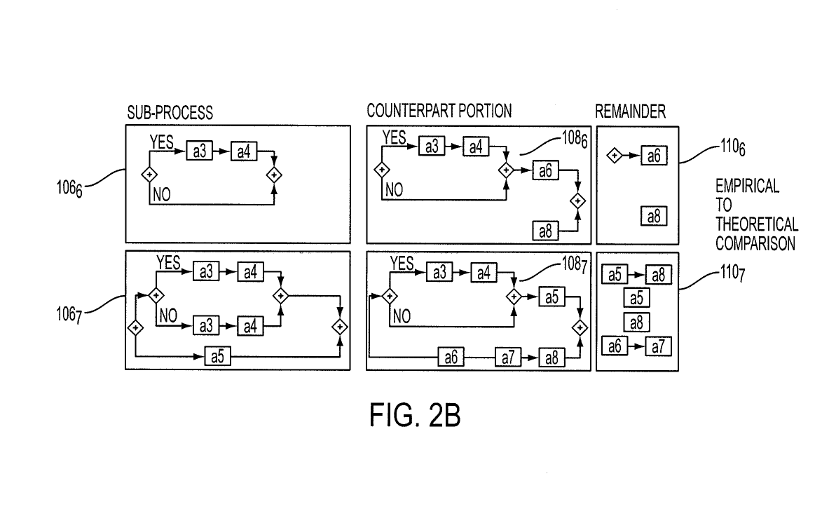

FIGS. 2A and 2B illustrate example sub-process graphs 106 that can be decomposed from the theoretical process graph 102. In one embodiment, the sub-process graphs 106 can be used to obtain a partition or a decomposition of the theoretical process that is easily recognizable or obtainable by a business analyst given the original process definition. For example, a sub-process graph 106 could be the flow of activities for scheduling a conference within a larger Child Support process.

It should be noted that the number of sub-process graphs 106 is a function of a size of the theoretical process graph 102 and may vary as noted above. Thus, the number of sub-process graphs 106 illustrated in FIGS. 2A and 2B are only an example and should not be considered limiting.

In one embodiment, the theoretical process graph 102 may be decomposed by a series of order levels that go from very specific to very general or broad. For example, level 1 may include the sub-process graphs 106₁, 106₂ and 106₃, level 2 may include the sub-process graphs 106₄ and level 3 include the sub-process graph 106₄, which includes the entire theoretical process graph 102. It should be noted that the numbering of the levels may be arbitrary. For example, the granularity may decrease as the level number goes higher (e.g., level 1 may be the biggest sub-process graph 106 and level 3 may include the smallest or most specific sub-process graph 106). In another example, the broadest sub-level graph 106 may be level 0 and the level of granularity may be increased from level 1 on up.

It should be noted that FIGS. 2A and 2B may not necessarily illustrate all of the sub-process graphs 106 that are possible from the theoretical process graph 102. For example, FIG. 2A only illustrates a few examples and the theoretical process graph 102 may be decomposed into additional sub-process graphs 106 that are not shown.

In one embodiment, each one of the sub-process graphs 106 may be compared to a portion 108 of the empirical process graph 104 that corresponds to the sub-process graph 106. In one embodiment, the portion 108 that corresponds to a sub-process graph 106 may be defined in general as the smallest graph within the empirical process graph 104 that contains all activities of the sub-process graph 106. For example, in FIG. 2A the sub-process graph 106₁ may be compared to the portion 108₁. When the sub-process graph 106₁ is compared to the portion or counterpart 108₁, the difference may be used to calculate the remainder 110₁.

In other words, the remainder 110 may comprise one or more decision boxes 120 or one or more activity boxes 122 that are not common to the sub-process graph 106 being analyzed or processed and the corresponding portion 108 that the sub-process graph 106 is being compared to.

In one embodiment, the identification of the portions 108 that correspond to each one of the sub-process graphs 106, and the comparisons of each, may be iteratively repeated until all of the sub-process graphs 106 are processed to calculate its respective remainders 110. In one embodiment, the comparison may be made in both directions. For example, the comparison may be made in a first direction from the theoretical process graph 102 to the empirical process graph 104 (e.g., sub-process graphs 106₁ to 106₅ in FIG. 2). The comparison may also be made in a second direction from the empirical process graph 104 to the theoretical process graph 102 (e.g., sub-process graphs 106₆ and 106₇ in FIG. 2B).

In one embodiment, the second direction may compare portions 108 to a different set of the sub-process graphs 106 that were not already analyzed or processed in the first direction, depending on the process of identifying theoretical counterparts for those portions 108. In other words, when performing the comparison in the second direction the different sub-process graphs 106 may also be identified as the smallest graph within the sub-process graph 106 that contains all activities of the portions 108. As a result, the number of sub-process graphs 106 may differ for both directions.

In one embodiment, the calculation of the remainders may be performed in accordance with an algorithm 1 and an algorithm 2 shown below.

ALGORITHM 1

Input:

| - | K sub-processes obtained from the theoretical process (T) |
|---|---|
| | decomposition |
| - | The empirical process E |

Output:

| | |
|---|---|
| - | Output list_TE |
| - | Output list_ET |

Algorithm:

| - | theo_set = all K sub-processes from the theoretical process |
|---|---|
| | decomposition |
| - | emp_set = Ø |
| - | list_TE = Ø |
| - | list_ET = Ø |
| - | While not-visited sub-process exists in theo_set or emp_set: |

• Visit not-visited sub-process t in theo_set:

▪ {e, r} = find_counterpart_and_remainder(t, E)
▪ emp_set = emp_set ∪ { e } ∪ { r }
▪ if r is not empty, then add (t, e, r) to list_TE

• Visit not-visited sub-process e in emp_set:

▪ {t, r} = find_counterpart_and_remainder(e, T)
▪ if r is not empty, then add (e, t, r) to list_ET

ALGORITHM 2

| find_counterpart_and_remainders | | | |
|---|---|---|---|
| (s1, P) | | | merge |
| - Input: | | | Returns a set of maximally- |
| | • | a sub-process s1 | connected sub-processes by: |

| | | | |
|---|---|---|---|
| • | a reference process P | a) | either adding the |

| - Output: | | | given sub-process to |
|---|---|---|---|
| | • | Counterpart s2 of s1 in P | the original set, |

| | • | Remainder r of s2 with respect to | b) or connecting the |
|---|---|---|---|
| | | s1 | given sub-process to |
| - Algo: | | | an existing sub-process |
| | • | For each adjacent pair (parent, | in the original set. |

child) in s1:

| 1. | Find path (connecting |
|---|---|
| | parent and child) in P |
| 2. | If path exists: |

| a. | merge path into |
|---|---|
| | counterpart s2 |
| b. | merge |

path-{parent,
child} into
remainder r

| | |
|---|---|
| 3. | Else: |

| | |
|---|---|
| a. | merge {parent, |

child} into
counterpart s2
if they exist

merge {parent, child} into remainder r

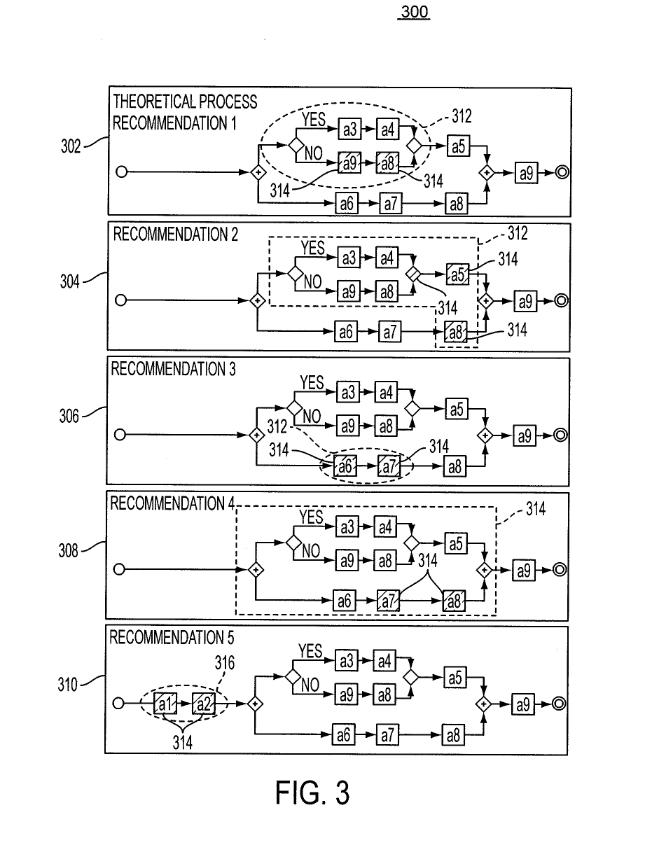

Once all of the remainders 110 are calculated for each one of the sub-process graphs 106, a recommendation comprising a list of one or more repairs may be displayed or presented to a user. FIG. 3 illustrates a recommendation 300 including one or more repairs 302-310. Each one of the repairs 302-310 may include a circled portion 312, which indicates the area of comparison and one or more differences 314. The one or more differences 314 indicate one or more decision boxes 120 or one or more activity boxes 122 that need to be added, removed, moved or modified to perform the recommended repair 302-310.

In one embodiment, two or more of the repairs 302-310 may be chained together as part of a single repair recommendation. For example, a first repair recommendation may include a repair to remove one or more activity boxes 122. A second repair recommendation may include a repair to add the same one or more activity boxes 122. Thus, the two repair recommendations may be chained together to be a repair to move the one or more activity boxes 122 from a combination of where the one or more activity boxes 122 should be removed in the first repair to where the one or more activity boxes 122 should be added in the second repair.

In one embodiment, each one of the repairs 302-310 may correspond to one of the remainders 110 calculated for each one of the sub-process graphs 106, as discussed above. In one embodiment, the repairs 302-310 may be presented in the recommendations 300 in an ordered list based on the order level of the corresponding sub-process graphs 106 and remainders 110. For example, the recommendations 300 may be presented in an order of decreasing granularity as the recommendations 302, 304 and 306 may correspond to the level 1 sub-process graphs 106₁, 106₂ and 106₃. The next recommendation may be based on the level 2 sub-process graph 106₄, the last recommendation may be based on the level 3 sub-process graph 106₅, and so forth.

In another embodiment, the recommendations 300 may be presented in an order of frequency of one or more activities associated with each one of the repairs 302-310. For example, if the activity box a5 of the repair 302 occurs with a highest frequency then the repair 302 may be recommended first. In contrast, if the activity box a1 of the repair 310 occurs with a lowest frequency than the repair 310 may be recommended last, and so forth.

From the recommendations 300, a user may select one of the repairs 302-310. The selected repair may then be automatically implemented. In other words, the theoretical process graph 102 may be repaired to make the appropriate changes included in the selected repair. For example, one or more decision boxes 120 and/or one or more activity boxes 122 may be added, removed, moved or modified in the theoretical process graph 102.

It should be noted that the user is not required to select any or all of the recommended repairs 302-310. The user may select one or more of the recommended repairs 302-310. Thus, the present disclosure allows a user to quickly and easily identify differences between the empirical process graph 104 and the theoretical process graph 102 using an objective comparison.

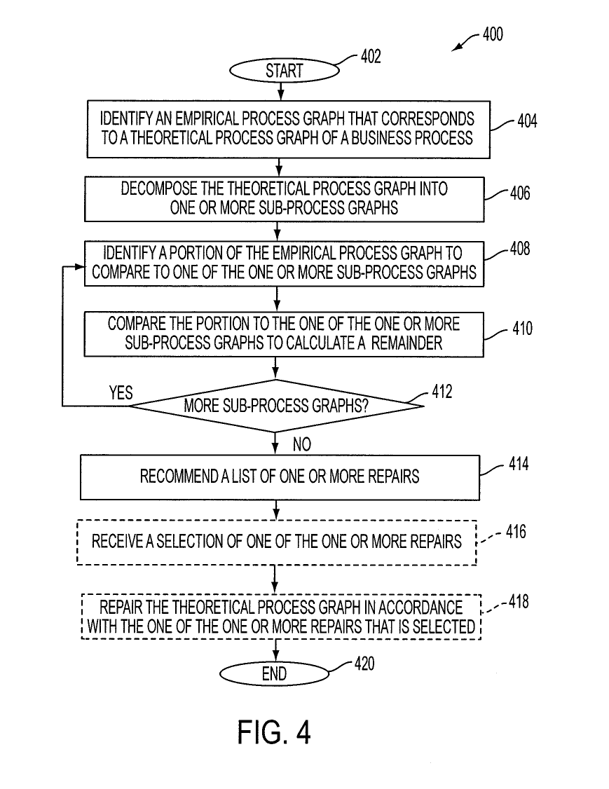

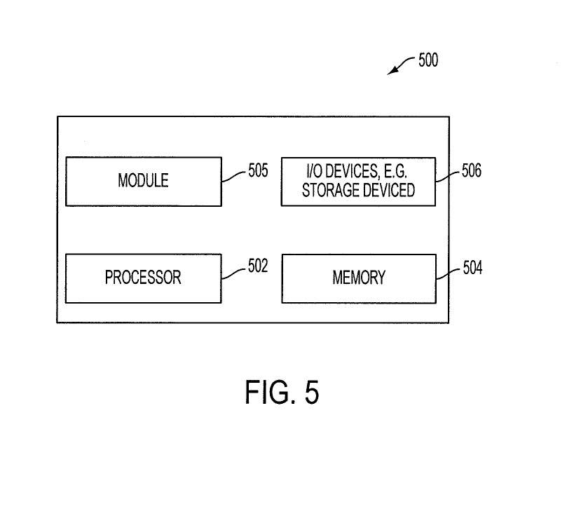

FIG. 4 illustrates a flowchart of a method 400 for recommending a repair for a business process. In one embodiment, one or more steps or operations of the method 400 may be performed by a general-purpose computer as illustrated in FIG. 5 and discussed below.

At step 402 the method 400 begins. At step 404, the method 400 identifies an empirical process graph that corresponds to a theoretical process graph of a business process. In one embodiment, the theoretical process graph may be created by an analyst of a company and stored for later analysis and processing as described herein. In one embodiment, the empirical process graph may be constructed based on processing mining and BAM data of a company.

The empirical process graph may be a visual representation of the decisions and activities that are actually occurring versus the decisions and activities that theoretically should be occurring in the theoretical process graph. One embodiment of creating the empirical process graph is disclosed in U.S. patent application Ser. No. 14/081,203, filed on Nov. 15, 2013, entitled “A Method and System For Clustering, Modeling and Visualizing Process Models From Noisy Logs,” assigned to Xerox® Corporation and herein incorporated by reference in its entirety. Another embodiment of discovering the empirical process graph 104 that corresponds specifically to a given theoretical process model is disclosed in U.S. patent application Ser. No. 14/017,861, filed on Sep. 4, 2013, entitled “Business Process Behavior Conformance Checking and Diagnostic Method And System Based On Theoretical And Empirical Process Models Built Using Probabilistic Models And Fuzzy Logic,” assigned to Xerox® Corporation and herein incorporated by reference in its entirety.

At step 406, the method 400 decomposes the theoretical process graph into one or more sub-process graphs. In one embodiment, the theoretical process graph may be decomposed by a series of order levels that go from very specific to very general or broad. The number of sub-process graphs that the theoretical process graph is decomposed into may be a function of a size of the theoretical process graph and a number of possible different combinations of the decision boxes and/or activity boxes included in the theoretical process graph, or may be a result of the human-generated design of the process, where hierarchies of activities and sub-activities (and so forth) are typically identified.

At step 408, the method 400 identifies a portion of the empirical process graph to compare to one of the one or more sub-process graphs. In one embodiment, the portion that corresponds to a sub-process graph may be defined in general as the smallest graph within the empirical process graph that contains all activities of the sub-process graph. Conversely, when performing a comparison in a second direction (as discussed above) different sub-process graphs may also be identified as the smallest graph within the sub-process graph that contains all activities of the empirical process graph.

At step 410, the method 400 compares the portion to the one of the one or more sub-process graphs to calculate a remainder. When the sub-process graph is compared to the portion or counterpart, the difference may be calculated as the remainder. In other words, the remainder may comprise one or more decision boxes or one or more activity boxes that are not common to the sub-process graph being analyzed or processed and the corresponding portion that the sub-process graph is being compared to. In one embodiment, Algorithm 1 and Algorithm 2 may be used to calculate the remainders.

In one embodiment, the comparison may occur in both directions. For example, the comparison may be made in a first direction from the theoretical process graph to the empirical process graph and in a second direction from the empirical process graph to the theoretical process graph.

At step 412, the method 400 determines if there are more sub-process graphs that need to be processed or compared to a portion of the empirical process graph. If there are more sub-process graphs, the method 400 returns to step 408 and the identifying and comparing steps 408 and 410, respectively, are iteratively repeated until all of the sub-process graphs are processed. If there are no more sub-process graphs, the method 400 proceeds to step 414.

At step 414, the method 400 recommends a list of one or more repairs in accordance with the remainders calculated in step 410. Each one of the repairs may include one or more differences that indicate one or more decision boxes or one or more activity boxes that need to be added, removed, moved or modified to perform the recommend repair.

In one embodiment, each one of the repairs may correspond to one of the remainders calculated for each one of the sub-process graphs, as discussed above. In one embodiment, the repairs may be presented in the recommendations in an ordered list based on the order level of the corresponding sub-process graphs and remainders. For example, the recommendations may be presented in an order of decreasing granularity.

In another embodiment, the recommendations may be presented in an order of frequency of one or more activities associated with each one of the repairs. For example, if a first activity box of a first repair occurs with a highest frequency then the first repair may be recommended first. In contrast, if a second activity box of a second repair occurs with a lowest frequency than the repair may be recommended last, and so forth.

At optional step 416, the method 400 may receive a selection of one of the one or more repairs. For example, a user may select any one of the recommended repairs. The user is not required to select and implement all of the repairs presented in the recommendation of repairs.

At optional step 418, the method 400 may repair the theoretical process graph in accordance with the one of the one or more repairs that is selected. In other words, the theoretical process graph may be repaired to make the appropriate changes included in the selected repair. For example, one or more decision boxes and/or one or more activity boxes may be added, removed, moved or modified in the theoretical process graph. At step 420, the method 400 ends.

It should be noted that although not explicitly specified, one or more steps, functions, or operations of the method 400 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 4 that recite a determining operation, or involve a decision, do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises one or more hardware processor elements 502 (e.g., a central processing unit (CPU), a microprocessor, or a multi-core processor), a memory 504, e.g., random access memory (RAM) and/or read only memory (ROM), a module 505 for recommending a repair for a business process, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for recommending a repair for a business process (e.g., a software program comprising computer-executable instructions) can be loaded into memory 504 and executed by hardware processor element 502 to implement the steps, functions or operations as discussed above in connection with the exemplary method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for recommending a repair for a business process (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for recommending a repair for a business process, comprising:
identifying, by a processor, an empirical process graph that corresponds to a theoretical process graph of the business process;
decomposing, by the processor, the theoretical process graph into one or more sub-process graphs;
identifying, by the processor, a portion of the empirical process graph to compare to one of the one or more sub-process graphs;
comparing, by the processor, the portion of the empirical process graph to the one of the one or more sub-process graphs to calculate a remainder;
repeating, by the processor, the identifying and the comparing for each one of the one or more sub-process graphs; and
recommending, by the processor, a list of one or more repairs, wherein each one of the one or more repairs corresponds to a respective remainder calculated in the comparing.

2. The method of claim 1, wherein the one or more sub-process graphs are decomposed in accordance with an order level.

3. The method of claim 2, wherein the one or more repairs are ordered in the order level in the list.

4. The method of claim 2, wherein the one or more repairs are ordered by a frequency of one or more activities associated with each one of the one or more repairs.

5. The method of claim 1, wherein the portion of the empirical process graph that is identified is the portion of the empirical process graph that comprises a smallest graph that contains all activities of the one of the one or more sub-process graphs.

6. The method of claim 1, wherein the remainder comprises one or more additional activities that differ from the one of the one or more sub-process graphs and the portion of the empirical process graph that is identified.

7. The method of claim 1, wherein the comparing comprises an iterative process that compares in a first direction comprising the theoretical process graph to the empirical process graph and a second direction comprising the empirical process graph to the theoretical process graph.

8. The method of claim 1, further comprising:
repairing, by the processor, the theoretical process graph in accordance with one of the one or more repairs that is selected.

9. The method of claim 8, wherein the repairing comprises adding a remainder to the theoretical process graph.

10. The method of claim 8, wherein the repairing comprises subtracting a remainder to the theoretical process graph.

11. A non-transitory computer-readable medium storing a plurality of instructions which, when executed by a processor, cause the processor to perform operations for recommending a repair for a business process, the operations comprising:
identifying an empirical process graph that corresponds to a theoretical process graph of the business process;
decomposing the theoretical process graph into one or more sub-process graphs;
identifying a portion of the empirical process graph to compare to one of the one or more sub-process graphs;
comparing the portion of the empirical process graph to the one of the one or more sub-process graphs to calculate a remainder;
repeating the identifying and the comparing for each one of the one or more sub-process graphs; and
recommending a list of one or more repairs, wherein each one of the one or more repairs corresponds to a respective remainder calculated in the comparing.

12. The non-transitory computer-readable medium of claim 11, wherein the one or more sub-process graphs are decomposed in accordance with an order level.

13. The non-transitory computer-readable medium of claim of claim 12, wherein the one or more repairs are ordered in the order level in the list.

14. The non-transitory computer-readable medium of claim of claim 11, wherein the portion of the empirical process graph that is identified is the portion of the empirical process graph that comprises a smallest graph that contains all activities of the one of the one or more sub-process graphs.

15. The non-transitory computer-readable medium of claim of claim 11, wherein the remainder comprises one or more additional activities that differ from the one of the one or more sub-process graphs and the portion of the empirical process graph that is identified.

16. The non-transitory computer-readable medium of claim of claim 11, wherein the comparing comprises an iterative process that compares in a first direction comprising the theoretical process graph to the empirical process graph and a second direction comprising the empirical process graph to the theoretical process graph.

17. The non-transitory computer-readable medium of claim of claim 11, further comprising:
repairing the theoretical process graph in accordance with one of the one or more repairs that is selected.

18. The non-transitory computer-readable medium of claim of claim 17, wherein the repairing comprises adding a remainder to the theoretical process graph.

19. The non-transitory computer-readable medium of claim of claim 17, wherein the repairing comprises subtracting a remainder to the theoretical process graph.

20. A method for recommending a repair for a business process, comprising:
identifying, by a processor, an empirical process graph that corresponds to a theoretical process graph of the business process, wherein the theoretical process graph comprises one or more activities and one or more decision boxes organized in accordance with the business process and the empirical process graph comprises one or more of the one or more activities or the one or more decision boxes;
decomposing, by the processor, the theoretical process graph into one or more sub-process graphs, wherein the one or more sub-process graphs are grouped by an order level that defines a granularity of the one or more sub-process graphs;
identifying, by the processor, a portion of the empirical process graph to compare to one of the one or more sub-process graphs, wherein the portion of the empirical process graph that is identified is the portion of the empirical process graph that comprises a smallest graph that contains all activities of the one of the one or more sub-process graphs;
comparing, by the processor, the portion of the empirical process graph to the one of the one or more sub-process graphs to calculate a remainder, wherein the remainder comprises one or more additional activities that differ from the one of the one or more sub-process graphs and the portion of the empirical process graph that is identified;
repeating, by the processor, the identifying and the comparing for each one of the one or more sub-process graphs;
recommending, by the processor, a list of one or more repairs, wherein each one of the one or more repairs corresponds to a respective remainder calculated in the comparing;
receiving, by the processor, a selection of one of the one or more repairs; and
repairing, by the processor, the theoretical process graph in accordance with one of the one or more repairs that is selected.
